(19) United States
(12) Patent Application Publication
(10) Pub. No.: US 2018/0112051 A1
(43) Pub. Date: Apr. 26, 2018

(54) METHOD FOR PRODUCING SHAPED BODIES HAVING A RADIATION-CURED COATING

(71) Applicant: Covestro Deutschland AG, Leverkusen (DE)

(72) Inventors: Konstantin LEONHARDT, Grevenbroich (DE); Joachim PETZOLDT, Monheim (DE); Roland KÜNZEL, Leverkusen (DE)

(21) Appl. No.: 15/566,036

(22) PCT Filed: Apr. 11, 2016
(86) PCT No.: PCT/EP2016/057876

§ 371 Date: Oct. 12, 2017

(30) Foreign Application Priority Data
Apr. 14, 2015 (EP) 15163494.6
Nov. 26, 2015 (EP) 15196508.4

(51) Int. Cl. C08J 7/18; C09D 175/14; C08J 7/04; B29C 49/00

(52) U.S. Cl. CPC C08J 7/18; C09D 175/14; B29L 2007/00; B29C 49/0005; C08J 7/047

(57) ABSTRACT

The present invention relates to a method for producing shaped bodies having a radiation-cured coating, comprising the steps of:—providing a coated film, wherein the film comprises a radiation-curable coating, wherein the coating comprises a polyurethane polymer which has (meth)acrylate groups and is obtainable from the reaction of a reaction mixture comprising: (a) polyisocyanates and (b1) compounds which comprise (meth)acrylate groups and are reactive toward isocyanate, (b2) at least one photoinitiator, and wherein the coating further comprises inorganic nanoparticles having a median particle size of=1 nm to =200 nm,—forming the shape body,—curing the radiation-curable coating by means of LED UV radiation.

The present invention relates to a method for producing shaped bodies having a radiation-cured coating, wherein the coating comprises a polyurethane polymer which has (meth)acrylate groups and wherein the radiation hardening of the coating is achieved by means of LED UV radiation. Furthermore, this invention also relates to the shaped bodies which can be produced by this method.

Methods are known wherein, firstly, a plastic film is coated extensively by common painting processes such as by squeegee or spraying and this coating is dried by physical drying or partial hardening until it is practically tack-free. This film can then be deformed at elevated temperatures and then glued, back-sprayed or back-foamed. This concept offers a great deal of potential for producing, for example, building components by plastics processors, wherein the more expensive painting stage of three-dimensional building components can be replaced by the simpler coating of a flat substrate.

As a rule, good surface properties require that the cross-linking of the coating is dense. However, highly dense cross-linking results in a thermoset-type of behaviour wherein the maximum degree of extension possible is just a few percent so that the coating has a tendency to form cracks during the deformation process. This obvious conflict between a necessary highly dense cross-linking and a desired high degree of extension can be resolved by performing the drying/curing of the coating in two steps, before and after the deformation. A radiation-induced cross-linking reaction in the coating is particularly suitable for post-curing.

Furthermore, to apply this method efficiently, the coated, deformed film has to be wound into rolls in the interim. The pressure and temperature stresses occurring in the rolls in this operation present special demands on the blocking resistance of the coating.

WO 2005/080484 A1 describes a radiation-curable composite sandwich panel or film of at least one substrate layer and a top layer which contains a radiation-curable mass with a glass transition temperature below 50° C. with a high double bonding density.

WO 2005/118689 A1 discloses an analogous composite sandwich panel or film wherein the radiation-curable mass contains additional acid groups. Both applications describe the top layer as non-adhesive where a higher blocking resistance, needed, for example, to roll the film around a core, is not achieved. The possibility of winding the composite films into rolls before the radiation curing of the top layer is not mentioned, therefore.

WO 2005/099943 A2 describes a flexible multilayer composite with a carrier and at least one layer of curable paint applied to the carrier, wherein the layer of curable paint has a double-bond-containing binder with a double bonding density between 3 mol/kg and 6 mol/kg, with a glass transition temperature Tg between −15° C. to 20° C. and a solid body content between 40% and 100% which is not tacky after thermal drying. The text teaches that, due to the low Tg, the coating can be dust-prone. In the example, a degree of drying/a blocking resistance of the coating is achieved before the radiation hardening, wherein erosion of a filter paper is visible after being subjected to a load of 500 g/cm² for 60 sec at 10° C. The stresses on a coating in a film roll are normally higher regarding pressure and temperature. The possibility of winding up the films on to rolls before the radiation curing of the paint is not mentioned, therefore, in this text either.

Also, none of the applications cited so far mention the application of nanoscale particles as a component part of the radiation-curable coating.

WO 2006/008120 A1 discloses an aqueous dispersion of nanoscale polymer particles of organic binders, wherein nanoparticles are contained in them as a highly dispersed phase, as well as water and/or an aqueous colloidal solution of a metal oxide as a continuous phase as well as optional supplementary substances and additives. These types of aqueous composition can be used as a paint composition for coating purposes.

The drying properties of these systems are not discussed but, due to the low molecular weights, block resistances are low, in particular for the polyurethane systems. The application of these systems for coating of films is not mentioned.

Likewise, there is no indication in this text of about the behaviour of such a dispersion if it is carried on a thermoplastic film and the film is deformed. Such coatings must adhere sufficiently, in particular, to the film substrate. Furthermore, it is advantageous, as mentioned already, to have the highest possible blocking resistance so that the coated but uncured film can be rolled up into rolls.

EP-A 2113527 discloses a film comprising a radiation-curable coating, wherein the coating comprises a polyurethane polymer, which has (meth)acrylate groups and which is obtained from the reaction of a reaction mixture comprising:

(a) polyisocyanates and

(b1) compounds which are reactive to isocyanates and which comprise (meth)acrylate groups

and wherein the coating also comprises inorganic nanoparticles with a mean particle size of ≥1 nm to ≤200 nm. Furthermore, EP-A 2113527 discloses a method for producing such coated films, the application of such films for producing shaped bodies, a method for producing shaped bodies with a radiation-cured coating and shaped bodies producible by this method. The radiation curing is performed with conventional UV radiation.

The curing of coating by UV radiation has been established in only a few fields, such as in the curing of adhesives and in the field of inkjet printing technology.

The curing of the radiation-curable coating by UV radiation is performed in the production of shaped bodies with coated films. Normally, the UV curing uses Hg vapour lamps. Due to their wide emission spectrum, these generate ozone and a lot of heat. Furthermore, they consume a large amount of energy while the shaped bodies are being produced. Thus, the use of LED UV radiation would be desirable in the production of shaped bodies with coated films to save energy, since short switching times are possible with LED UV radiation compared with conventional UV radiation. Also, when LED UV radiation is used in the curing, there is no ozone and a longer service life can be anticipated for the LED UV emitters which is advantageous with respect to occupational safety and ecological aspects.

It would be desirable that, after the deformation and curing by LED UV radiation, the coating of the films would display high abrasion resistance and good adhesion to the film at the same time.

The task set for the present invention is to produce a method for producing coated shaped bodies which has a high energy efficiency, wherein, after the deformation and curing, the coatings of the films display high abrasion resistance and good adhesion to the film at the same time.

The present invention relates to a method for producing shaped bodies having a radiation-cured coating, comprising the steps:
preparation of a coated film, wherein the film comprises a radiation-curable coating, wherein the coating comprises a polyurethane polymer, which has (meth)acrylate groups and is obtainable from the reaction of a reaction mixture comprising:
   (a) polyisocyanates and
   (b1)) compounds which are reactive to isocyanates and which comprise (meth)acrylate groups,
   (b2) at least one photoinitiator
and wherein the coating further comprises inorganic nanoparticles with a mean particle size of ≥1 nm to ≤200 nm,
shaping of the shaped body
curing the radiation-curable coating by LED UV radiation.
optionally after the curing with LED UV radiation, curing with UVC radiation.

In this process, the coated film is made into the desired final shape by thermal deforming. This can be done by methods such as deep drawing, vacuum forming, pressing or blow moulding.

After the deformation step, the coating of the film is finally cured by irradiating with LED UV radiation. Optionally, further curing using UVC radiation to reduce scratch resistance can be added.

The shaped bodies produced by this method can have structural elements curved with very small radii.

Radiation hardening by LED UV radiation is meant as the radical polymerisation of ethylenically unsaturated carbon-carbon double bonds by means of initiator radicals released by irradiating with LED UV radiation from the photoinitiators, for example.

The radiation hardening is carried out preferably by the effect of LED UV radiation with a quasi-monochromatic emission spectrum with defined wavelengths in the range ≥360 nm to ≤410 nm, preferably with defined wavelengths in the range 365 nm, 375 nm, 385 nm, 395 nm and/or 405 nm. The emission spectrum has no short wavelengths which are typical for the spectrum the UV Hg emitters. The LED emitters are based on semiconductor technology. When current is applied, the specific wavelengths are emitted directly.

UVC emitters which can be used as an additional option for curing with LED radiation are used in the wavelength range 200 to 280 nm. Conventionally, UV Hg medium pressure emitters are used for this. The emitters can be installed fixed in location so that an item to be radiated by a mechanical device is passed by the radiation source, or the emitter can be mobile, and the item to be radiated does not change its location during the curing.

The irradiation can also be performed, if necessary, by excluding oxygen, for example, in an inert gas atmosphere or an oxygen-reduced atmosphere. Suitable inert gases are preferably nitrogen, carbon dioxide, noble gases or flue gases. Moreover, the irradiation can be performed while the coating is covered with media which is transparent for the radiation. Examples of these include, for example, plastic films, glass or fluids such as water.

For curing the deformed films, it is especially advantageous to perform the curing with a plurality of emitters whose arrangement is selected such that each point of the coating as far as possible receives the optimal dosage and intensity of radiation for curing. In particular, areas that are not irradiated must be avoided (shadow zones).

Furthermore, depending on the film used, it can be advantageous to use a heating lamp before or during the irradiation by LED emitters in order to achieve the temperatures needed for cross-linking.

The resulting cured, coated, deformed film displays very good resistance to solvents, dyeing fluids which are present in households, as well as being very hard, having good resistance to scratches and abrasion, coupled with high optical transparency. This can be increased, in particular, by additional curing with UVC radiation.

In one embodiment, the shaping of the shaped body takes place in a tool at a pressure of ≥20 bar to ≤150 bar, Preferably the pressure in this high pressure deformation method is in a range ≥50 bar to ≤120 bar or in a range ≥90 bar to ≤110 bar. The pressure to be applied is determined, in particular, by the thickness of the film being shaped and the temperature as well as the film material used.

In a further embodiment, the shaping of the shaped body takes place at a temperature of ≥20° C. to ≤60° C. below the softening temperature of the material of the film. Preferably, this temperature is ≥30° C. to ≤50° C. or is ≥40° C. to ≤45° C. below the softening temperature. This method comparable to cold forming has the advantage that thinner films can be used that follow the shape more precisely. Another advantage is that cycle times are shorter and there is less them al stress on the coating. Such deformation temperatures are used advantageously in combination with a high pressure deformation method.

In a further embodiment, the method also comprises the step:
application of a polymer on the side of the film opposite the cured layer.

The shaped coated film can be modified by methods such as, for example, back-spraying or even back-foaming possibly with filled polymers such as thermoplastics or even reactive polymers like two-component polyurethane systems before or preferably after the final curing. Here, an adhesive layer may also be used as a bonding agent. Shaped bodies that are produced where their surface is formed by the cured coating on the film have excellent performance characteristics.

A further subject matter of the invention is a shaped body, producible by a method according to the present invention. Such shaped bodies can be, for example, vehicle components, plastic parts such as panels for the interior structures of vehicles and/or aircraft, furniture making, electronic devices, communication apparatus, housings or decorative objects.

Besides the required general resistance, the film to be used according to the invention advantageously has, above all, the required thermal deformability. Thus, those thermoplastic polymers which are generally suitable, include, in particular ABS, AMMA, ASA, CA, CAB, EP, UT, CF, MF, MPF, PF, PAN, PA, PE, HDPE, LDPE, LLDPE, PC, PET, PMMA, PP, PS, SB, PUR, PVC, RF, SAN, PBT, PPE, POM, PP-EPDM, and UP (abbreviations complying with DIN 7728T1) and mixtures thereof, as well as composite films constructed from two or more layers of these plastics. In general, the films to be used according to the invention may also contain reinforcing fibres or fabrics insofar as they do not impair the desired thermoplastic deformation.

Thermoplastic polyurethanes, polymethylmethacrylate (PMMA) and modified variants of PMMA, as well as polycarbonate (PC), ASA, PET, PP, PP-EPDM and ABS are particularly suitable.

The film, or panel also, is used preferably in a thickness of ≥10 μm to ≤1500 μm, more preferably of ≥50 μm to ≤1000 μm and especially preferably of ≥200 μm to ≤400 μm. Additionally, the material of the film may contain additives and/or processing aids for film production, such as stabilisers, light stabilisers, softeners, fillers, such as fibres, and dyestuffs. The side of the film provided for coating as well as the other side of the film can be smooth or have a surface structure, wherein a smooth surface of the side to be coated is preferred.

In one embodiment, the film is a polycarbonate film with a thickness of ≥10 μm to ≤1500 μm. This also includes a polycarbonate film with the aforementioned additives and/or processing aids. The thickness of the film can also be ≥50 μm to ≤1000 μm or ≥200 μm to ≤400 μm.

The film can be coated on one or on both sides wherein one-sided coating is preferred. In the case of one-sided coating, optionally a thermally deformable adhesive layer can be applied on the reverse side of the film, i.e. on the surface on which the coating agent is not applied. Preferably hot melt adhesives or radiation-curable adhesives are suitable for this depending on the process. In addition, a protective film can be applied to the surface of the adhesive layer which is also thermally deformable. Furthermore, it is possible to provide the film on the reverse side with carrier materials, such a fabrics but which should be deformable to the desired extent.

Optionally, the film can be painted or printed before or after the application of the radiation-curable layer with one or a plurality of layers. This can take place on the coated or on the uncoated side of the film. The layers can be chromophoric or functional, covered completely or just partially, for example, as a printed image. The paint used should be thermoplastic so that it will not tear during deforming which takes place later. Printing inks can be used which are available commercially for so-called “in-mould decoration” methods.

The radiation-curable coating of the film can represent the surface of everyday objects later. Provision is made, according to the invention, that it comprises a polyurethane polymer. This polyurethane polymer can also comprise other polymer units such as polyurea units, polyester units, and other similar units. The polyurethane polymer has (meth)acrylate groups. The term (meth)acrylate groups within the meaning of the present invention is meant as including acrylate groups and/or methacrylate groups. The (meth)acrylate groups can be bonded basically to any part of the polyurethane polymer or to other units on the polymer. For example, they can form part of a polyether- or polyester(meth)acrylate polymer unit.

The polyurethane having (meth)acrylate groups can occur and be used as a powdery solid, as a melt, as a solution or preferably as an aqueous dispersion. Aqueous dispersions offer the advantage of processing particularly high molecular weight polyurethanes in a coating agent with low dynamic viscosity since, with dispersions, the viscosity is independent of the molecular weight of the components of the dispersed phase.

Suitable dispersions include, for example, polyurethane dispersions having (meth)acrylate groups alone or in a mixture with polyaerylate dispersions having (meth)acrylate groups and/or low molecular compounds having (meth)acrylate groups and/or dispersed polymers without acrylate- or methacrylate groups.

According to the invention, provision is made that the polyurethane polymer having (meth)acrylate groups is obtainable from the reaction of a reaction mixture comprising:

(a) polyisocyanates and

(b1) compounds reactive to isocyanates and comprising (meth)acrylate groups

(b2) at least one photoinitiator

Suitable polyisocyanates (a), in which diisocyanates are considered to be included also, are aromatic, araliphatic, aliphatic or cycloaliphatic polyisocyanates. Mixtures of such di- or polyisocyanates can also be used. Examples of suitable polyisocyanates are butylene diiso-cyanate, hexamethylene diisocyanate (HDI), isophorone diisocyanate (IPDI), 2,2,4 and/or 2,4,4-trimethylhexamethylene diisocyanate, the isomers bis(4,4′-isocyanato cyclohexyl)-methane or their mixtures of any isomer content, isocyanatomethyl-1,8-octa diisocyanate, 1,4-cyclohexylene diisocyanate, 1,4-phenylene diisocyanate, 2,4- and/or 2,6-toluene diiso-cyanate, the isomers xylene diisocyanates, 1,5-naphthylene diisocyanate, 2,4′- or 4,4′-di-phenylmethane diisocyanate, triphenylmethane-4,4′,4″-triisocyanate or their derivates with urethane-, isocyanurate-, allophanate-, biuret-, oxadiazintrione,- uretdione-, iminooxa-diazine dione structure and mixtures thereof. Preferably di- or polyisocyanates having a cycloaliphatic or aromatic structure are preferred since a higher proportion of these structural elements have a positive effect on the drying properties, in particular the blocking resistance of the coating before the UV curing. Particularly preferable diisocyanates are isophorone diisocyanate and the isomers bis(4,4′-isocyanato cyclohexyl)methane and mixtures thereof.

The components (b1) preferably comprise hydroxy-functional acrylates or methacrylates. Examples are 2-hydroxyethyl(meth)acrylate, polyethylene oxide mono(meth)acrylates, polypropylene oxide mono(meth)acrylates, polyalkylene oxide mono(meth)acrylates, poly(ε-caprolactone)mono(meth)acrylates, such as Pemcure® 12A (Cognis, Düsseldorf, DE), 2-hydroxypropyl(meth)acrylate, 4-hydroxybutyl(meth)acrylate, 3-hydroxy-2,2-dimethylpropyl(meth)acrylate, the acrylic acid- and/or methacrylic acid partial esters of polyvalent alcohols such as trimethylolpropane, glycerine, pentaerythritol, dipentaerythritol, sorbitol, ethoxylated, propoxylated or alcoxylated trimethylolpropane, glycerine, pentaerythritol, dipentaerythritol or technical mixtures thereof. The acrylated monoalcohols are preferred. Alcohols are also suitable which can be obtained from the reaction of double bond-containing acids with, where appropriate, double bond-containing monomeric epoxide compounds, for example, the reaction products of (meth)acrylic acid with glycidyl(meth)acrylate or the glycidyl ester of versatic acid.

Furthermore, compounds containing isocyanate-reactive oligomeric or polymeric unsaturated (meth)acrylate groups can be used alone or in combination with the above monomeric compounds. Preferably hydroxyl group-containing polyester acrylates with an OH content of ≥30 mg KOH/g to ≤300 mg KOH/g, preferably ≥60 mg KOH/g to ≤200 mg KOH/g, particularly preferably ≥70 mg KOH/g to ≤120 mg KOH/g are used as components (b1). A total of 7 groups of monomer components can be used in the production of the hydroxyl functional polyester acrylates:

1. (cyclo)alkane diols such as divalent alcohols with (cyclo)aliphatically bound hydroxyl groups in the molecular weight range of ≥62 g/mol to ≤286 g/mol, for example, ethanediol, 1,2- and 1,3-propanediol, 1,2-, 1,3- and 1,4-butanediol, 1,5-pentanediol, 1,6-hexanediol, neopentyl glycol, cyclohexane-1,4-dimethanol, 1,2- and 1,4-cyclohexanediol, 2-ethyl-2-butylpropanediol, ether oxygen-containing diols, such as diethylene glycol, triethylene glycol, tetraethylene glycol, dipropylene glycol, tripropylene glycol, polyethylene, polypropylene- or polybutylene glycols with a molecular weight of ≥200 g/mol to ≤4000 g/mol, preferably ≥300 g/mol to ≤2000 g/mol, particularly preferably ≥450 g/mol to ≤1200 g/mol. Reaction products of the aforementioned diols with ε-caprolactone or other lactones can also serve as diols.

2. Trivalent and higher order alcohols in the molecular weight range ≥92 g/mol to ≤254 g/mol, such as, glycerine, trimethylolpropane, pentaerythritol, dipentaerythritol and sorbitol or polyethers started on these alcohols such as the reaction product of 1 mol of trimethylolpropane with 4 mols of ethylene oxide.

3. Mono alcohols such as, ethanol, 1- and 2-propanol, 1- and 2-butanol, 1- hexanol, 2-ethylhexanol, cyclohexanol and benzyl alcohol.

4. Dicarbon acids of the molecular weight range ≥104 g/mol to ≤600 g/mol and/or their anhydrides, such as phthalic acid, phthalic acid anhydride, isophthalic acid, tetra hydrophthalic acid, tetra-hydrophthalic acid anhydride, hexahydrophthalic acid, hexahydrophthalic acid anhydride, cyclohexane dicarboxylic acid, maleic acid anhydride, fumaric acid, malonic acid, bernstein acid, bernstein acid anhydride, glutaric acid, adipinic acid, pimelinic acid, suberic acid, sebacic acid, dodecanoic acid, hydrated dimer fatty acids.

5. Higher functional carbon acids or their anhydrides such as trimellitic acid and trimellitic acid anhydride.

6. Monocarboxylic acids, such as benzoic acid, cyclohexanecarboxylic acid, 2-ethyl-hexane acid, caproic acid, caprylic acid, caprinic acid, lauric acid, natural and synthetic fatty acids.

7. Acrylic acid, methacrylic acid or dimeric acrylic acid.

Suitable hydroxyl group-containing polyester acrylates comprise the reaction product of at least one component from group 1 or 2 with at least one component from group 4 or 5 and at least one component from group 7.

If applicable, groups acting as dispersants can also be incorporated in these polyester acrylates. Thus, polyethylene glycols and/or methoxypolyethylene glycols can be used jointly in proportion as alcohol components. For example, polyethylene glycols, polypropylene glycols and their block copolymers as well as the monomethyl ethers of these polyglycols started on alcohols are cited as compounds. Polyethylene glycol-1500-and/or polyethylene glycol-500-mono-methyl ether is/are particularly suitable.

Furthermore, after the esterification, it is possible to react a part of carboxylic groups, in particular, the (meth)acrylic acid, with mono-, di- or polyepoxides. The epoxides (glycidyl ethers) of monomeric, oligomeric or polymeric bisphenol-A, bisphenol-F, hexanediol, butanediol and/or trimethylolpropane or their ethoxylated and/or propoxylated derivates are preferred, for example. This reaction can be used, in particular, for increasing the OH-count of the polyester(meth)acrylate since an OH group appears each time in the epoxide/acid reaction. The acid value of the resulting product is between ≥0 mg KOH/g and ≤20 mg KOH/g, preferably between ≥0.5 mg KOH/g and ≤10 mg KOH/g and particularly preferably between ≥1 mg KOH/g and ≤3 mg KOH/g. The reaction is catalysed preferably by catalysts such as triphenylphosphine, thiodiglycol, ammonium- and/or phosphonium halogenides and/or zirconium- or tin compounds such as tin(II) ethylhexanoate.

Preferable components (b1) that are used include hydroxyl group-containing epoxy(meth)acrylates with an OH content of ≥20 mg KOH/g to ≤300 mg KOH/g, preferably of ≥100 mg KOH/g to ≤280 mg KOH/g, particularly preferably of ≥150 mg KOH/g to ≤250 mg KOH/g or hydroxyl group-containing polyurethane (meth)acrylates with an OH content of ≥20 mg KOH/g to ≤300 mg KOH/g, preferably of ≥40 mg KOH/g to ≤150 mg KOH/g, particularly preferably of ≥50, mg KOH/g to ≤100 mg KOH/g as well as their mixtures of each other and mixtures with hydroxyl group-containing unsaturated polyesters as well as mixtures with polyester(meth)acrylates or mixtures of hydroxyl group-containing unsaturated polyesters with polyester(meth)acrylates. Hydroxyl group-containing epoxy(meth)acrylates are based, in particular, on reaction products of acrylic acid and/or methacrylic acid with epoxides (glycidyl compounds) of monomeric, oligomeric or polymeric bisphenol-A, bisphenol-F, hexanediol and/or butandiol or their ethoxylated and/or propoxylated derivates.

Inorganic oxides, mixed oxides, hydroxides, sulphates, carbonates, carbides, borides and nitrides of elements of the II to IV main group and/or elements of the I to VIII auxiliary group of the periodic system including the lanthanides can be considered for the inorganic nanoparticles present in the coating. Preferred particles are those from silicon oxide, aluminium oxide, ceroxid, zirconium oxide, niobium oxide and titanium oxide, and particularly preferred from these are silicon oxide nanoparticles.

The particles used have mean particle sizes of ≥1 nm to ≤200 nm, preferably of ≥3 nm to ≤50 nm, particularly preferably of ≥5 nm to ≤7 nm. The mean particle size can be determined preferably as the z-average by dynamic light scattering in dispersion. Below a 1 nm particle size, the nanoparticles reach the size of the polymer particles. Such small nanoparticles may result in an increase in the viscosity of the coating which is disadvantageous. Above 200 nm in particle size, the particles can be partially observed with the naked eye which is not desirable.

All particles used preferably have the sizes, defined above, of ≥75%, particularly preferably ≥90% quite particularly preferably ≥95%. The higher the coarse fraction in the particle totality, the worse become the optical properties of the coating, and clouding, in particular, can occur.

The particles can be selected such that the refractive index of their material corresponds to the refractive index of the cured radiation-curable coating. Then the coating has transparent optical properties. Advantageously, a refractive index is in the range of ≥1.35 to ≤1.45, for example.

The amounts of non-volatile parts of the radiation-curable layer can make up, for example, the following percentages. The nanoparticles can be present in amounts of ≥1% w/w to ≤60% w/w, preferably ≥5 w/w to ≤50% w/w and in particular of ≥10% w/w to ≤40% w/w. Other compounds can be present such as monomeric cross-linking in a proportion of ≥0% w/w to ≤40% w/w and in particular of ≥15% w/w to ≤20% w/w. The polyurethane polymer can then make up the difference to 100% w/w, As a general rule, the default applies that the sum of the individual proportions by weight comes to ≤100% w/w.

So-called secondary dispersions or emulsion polymerisates, containing low molecular compounds having co-emulsified (meth)acrylate groups can be considered as the aforementioned polyacrylate dispersions having (meth)acrylate groups. Secondary dispersions are produced by radical polymerisation of vinylic monomers such as styrol, acrylic acid, (meth)acrylic acid esters and similar in a solvent inert in terms of polymerisation and then dispersed in water by hydrophilically modified by internal and/or external emulsifiers. Incorporation of (meth)acrylate groups is possible by using monomers such as acrylic acid or glycidyl methacrylate in the polymerisation and these compounds, complementary in terms of an epoxide acid reaction, containing (meth)acrylate groups such as acrylic acid or glycidyl methacrylate are reacted before dispersion in a modification reaction.

Emulsion polymerisates containing the low molecular compounds having co-emulsified (meth)acrylate groups, are commercially obtainable, for example, Lux® 515, 805, 822 from Alberdingk&Boley, Krefeld, DE or Craymul® 2716, 2717 of Cray Valley, FR.

Preferably, polyacrylate dispersions have a higher glass transition temperature, which has a positive effect on the drying properties of the coating before the UV curing. A high proportion of low molecular compounds having co-emulsified (meth)acrylate groups can affect the drying properties negatively.

Emulsion polymerisates, for example, can be considered as the aforementioned dispersed polymers without acrylate- or methacrylate groups and are commercially available under the names Joncryl® (BASFAG, Ludwigshafen, DE), Neocryl (DSM Neoresins, Walwijk, NL) or Primal (Rohm&Haas Deutschland, Frankfurt, DE).

In a further embodiment of the present invention, the weight average mw of the polyurethane polymer is in a range ≥250000 g/mol to ≤350000 g/mol. The molecular weight can be determined by means of gel permeation chromatography (GPC). The weight average mw can be in a range ≥280000 g/mol to ≤320000 g/mol or ≥300000 g/mol to ≤310000 g/mol. Polyurethane dispersions with such molecular weights of the polymers can have good drying properties after application and, furthermore, good blocking resistance after drying.

The glass transition temperature, measured in particular by “differential scanning calorimetry” (DSC), is often hardly suitable for characterising the components of the radiation-curable layer. Frequently, due to the inconsistency of the polymeric and oligomeric components, and to the existence of more uniform building blocks, made fur example, of polyester diols with mean mol weights of 2000 and the degrees of branching of the polymers, few meaningful measurement value are obtained for the glass transition temperature. In particular, a glass transition temperature of a binder which consists of an organic polyurethane polymer and inorganic nanoparticles (“inorganic polymers”) can hardly be defined meaningfully. It should be noted, however, that an increase in components of an aromatic or cycloaliphatic nature in the polyurethane has a positive effect on the drying of the coating agent. Naturally, filming of the coating agent should take place possibly by adding ≥3% w/w to ≤15% w/w of solvent with higher boiling points than water.

Photoinitiators (b2) are initiators which can be activated by LTV LED radiation which initiates a radical polymerisation of the relevant polymerisable groups. Photoinitiators as such are known, commercially sold compounds, wherein there is a distinction between unimolecular (Type I) and bimolecular (Type II) initiators. (Type I) systems are, for example, aromatic ketone compounds, such as benzophenones in combination with tertiary amines, alkylbenzophenones, 4,4′-bis(dimethylamino)benzophenones (michler's ketone), anthrone and halogenated benzophenones or mixtures of the listed types. Other suitable (Type II) initiators include benzoin and its derivatives, benzil ketals, acyl phosphine-oxides, such as 2,4,6-trimethyl-benzoyl-diphenyl phosphine oxide, bis acyl phosphine oxides, phenylglyoxylic acid esters, camphor quinone, α-aminoalkyl phenones, α,α-dialcoxy acetophenones, α-hydroxy alkylphenones and oligomeric α-hydroxy alkylphenones. It may also be advantageous to use mixtures of these compounds. Suitable initiators are commercially available, for example, under the names Irgacure® and Darocur® (Ciba, Basel, CH) and Esacure® (Fratelli Lamberti, Adelate, IT).

Preferably, photoinitiators from the group consisting of acylphosphinoxides, such as 2,4,6-trimethyl-benzoyl-diphenylphosphine oxide, bisacyl phosphine oxides such as bis(2,4,6-trimethylbenzoyl)-phenyl phosphine oxide, α-hydroxyalkyl phenones, oligomeric α-hydroxyalkyl phenones such as oligo-[2-hydroxy-2-methyl-1-((4-(1-methyl vinyl)phenyl) propanone] and/or mixtures thereof are used as photoinitiators in the method according to the invention.

Particularly preferably, photoinitiators from the group consisting of α-hydroxyalkyl phenones, oligomeric α-hydroxyalkyl phenones such as oligo-[2-hydroxy-2-methyl-1-((4-(1-methylvinyl)phenyl) propanone] and/or mixtures thereof are used as photoinitiators in the method according to the invention.

In a further embodiment of the present invention, the reaction mixture to produce the polyurethane polymer having (meth)acrylate groups comprises the following components also:

(b3) hydrophilic-acting compounds with ionic and/or groups convertible into ionic groups and/or nonionic groups

(b4) polyol compounds with a mean molecular weight of ≥50 g/mol to ≤500 g/mol and a hydroxyl functionality of ≥2 and

(b5) amino functional compounds.

The component (b3) comprises ionic groups which can be either cationic or anionic in nature and/or nonionic hydrophilic groups. Cationic, anionic or nonionic dispersant active compounds are those, such as sulfonium-, ammonium-, phosphonium-, carboxylate-, sulfonate-, phosphonate groups or the groups which can be converted by salt formation into the above groups (potential ionic groups) or contain polyether groups and can be incorporated into the macromolecules by available isocyanate-reactive groups. Hydroxyl and amine groups are preferable as suitable isocyanate-reactive groups.

Suitable ionic or potentially ionic compounds (b3) include, for example, mono- and dihydroxycarboxylic acids, mono- and diaminocarboxylic acids, mono- and dihydroxy sulfonic acids, mono- and diaminosulfonic acids and mono- and dihydroxy phosphonic acids or mono- and diaminophosphonic acids and their salts such as dimethylolpropionic acid, dimethylolbutter acid, hydroxypivalic acid, n-(2-aminoethyl)-β-alanine, 2-(2-amino-ethylamino)-ethane sulfonic acid, ethylene diamine-propyl- or butyl sulfonic acid, 1,2- or 1,3-propylene diamine-β-ethylene sulfonic acid, malic acid, citric acid, glycolic acid, lactic acid, glycine, alanine, taurine, n-cyclohexylaminopropiosulfonic acid, lysine, 3,5-diamino-benzoic acid, addition products of IPDI and acrylic acid and its alkaline- and/or ammonium salts; the adduct of sodium bisulfite to butene-2-diol-1,4, polyethersulfonate, the propoxylated adduct from 2-butenediol and NaHSO₃, and building blocks convertible into cationic groups such as n-methyl-diethanolamine as hydrophilic attachment components. Preferable ionic or potentially ionic compounds include those having carboxy- or carboxylate- and/or sulfonate groups and/or ammonium groups. Particularly preferable ionic compounds are those containing the carboxylic- and/or sulfonate groups as ionic or potentially ionic groups, such as the salts of n-(2-aminoethyl)-β-alanine, of 2-(2-amino-ethylamino-)ethane sulfonic acid or of the addition products of IPDI and acrylic acid (EP-A 0 916 647, Example 1) and of dimethylolpropionic acid.

Suitable nonionic hydrophilic-acting compounds include, for example, polyoxyalkylene ethers, which contain at least one hydroxy- or amino group. These polyethers contain a proportion of ≥30% w/w to ≤100% w/w of building blocks derived from ethylene oxide. Linearly structured polyethers with a functionality between ≥1 and ≤3 are also considered, but also compounds with the general formula (I),

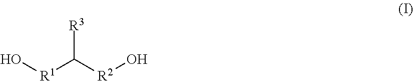

in which

R¹ and R² independent of each other, each represents a divalent aliphatic, cycloaliphatic or aromatic residue with 1 to 18 C atoms which can be interspersed with oxygen and/or nitrogen atoms, and

R³ stands for an alcoxy-terminated polyethylene oxide residue.

Nonionic hydrophilic-acting compounds are also, for example, monovalent polyalkylene oxide polyether alcohols, such as those obtainable by alcoxylation of suitable starter molecules, having statistically average ≥5 to ≤70, preferably ≥7 to ≤55 ethylene oxide units per molecule.

Suitable starter molecules are, for example, saturated mono alcohols such as methanol, ethanol, n-propanol, isopropanol, n-butanol, isobutanol, sec-butanol, the isomers pentanols, hexanols, octanols and nonanols, n-decanol, n-dodecanol, n-tetradecanol, n-hexadecanol, n-octadecanol, cyclohexanol, the isomers methylcyclohexanols or hydroxymethylcyclohexane, 3-ethyl-3-hydroxymethyl oxetane or tetrahydrofurfuryl alcohol, diethylene glycol-monoalkyl ethers such as diethylene glycol monobutyl ether, unsaturated alcohols such as allyl alcohol, 1,1-dimethylallyl alcohol or olein alcohol, aromatic alcohols such as phenol, the isomers cresols or methoxyphenols, araliphatic alcohols such as benzyl alcohol, aniseed alcohol or cinnamon alcohol, secondary monoamines such as dimethylamine, diethylamine, dipropylamine, diisopropylamine, dibutylamine, bis-(2-ethylhexyl)-amine, n-methyl- and n-ethylcyclohexylamine or dicyclohexylamine and heterocyclic secondary amines such as morpholine, pyrrolidine, piperidine or 1H-pyrazole. Preferable starter molecules are saturated mono alcohols. Particularly preferably, diethylene glycol monobutyl ether is used as a starter molecule. Alkylene oxides suitable for the alcoxylated reaction are, in particular, ethylene oxide and propylene oxide which can be used in any sequence or in the mixture also during the alcoxylated reaction.

The polyalkylene oxide polyether alcohols involve either pure polyethylene oxide polyethers or mixed polyalkylene oxide polyethers whose alkylene oxide units comprise ≥30 mol-%, preferably ≥40 mol-% of ethylene oxide units. Preferable nonionic compounds are monofunctional mixed polyalkylene oxide polyethers having ≥40 mol-% ethylene oxide units and ≤60 mol-% of propylene oxide units.

The components (b3) comprise preferably ionic hydrophilic-acting agents since nonionic hydrophilic-acting agents may have somewhat negative effects on the drying properties and, in particular, on the blocking resistance of the coating before the UV curing.

Suitable low molecular polyols (b4) are short-chained, aliphatic, araliphatic or cycloaliphatic diols or triols preferably containing ≥2 to ≤20 carbon atoms. Examples for diols are ethylene glycol, diethylene glycol, triethylene glycol, tetraethylene glycol, dipropylene glycol, tripropylene glycol, 1,2-propane diol, 1,3-propane diol, 1,4-butane diol, neopentyl glycol, 2-ethyl-2-butylpropane dial, trimethylpentane diol, positional isomeric diethyloctane diols, 1,3-butylene glycol, cyclohexane diol, 1,4-cyclohexane dimethanol, 1,6-hexane diol, 1,2- and 1,4-cyclohexane dial, hydrated bisphenol A (2,2-bis(4-hydroxycyclohexyl)propane), 2,2-dimethyl-3-hydroxypropionic acid-(2,2-dimethyl-3-hydroxypropyl ester). 1,4-butane diol, 1,4-cyclohexane dimethanol and 1,6-hexane diol are preferable. Examples of suitable triols are trimethylolethane, trimethylolpropane or glycerine, of which trimethylolpropane is preferable.

The components (b5) can be selected from the group of polyamines (which also include diamines), which are used to increase the molecular weight and are added preferably towards the end of the polyaddition reaction. Preferably this reaction takes place in the aqueous medium. Then, the polyamines should be more reactive than water to the isocyanate groups of components (a). Examples would include ethylene diamine, 1,3-propylene diamine, 1,6-hexamethylene diamine, isophorone diamine, 1,3-, 1,4-phenylene diamine, 4,4′-diphenylmethane diamine, amino-functional polyethyleneoxides or polypropylene oxides, which are obtainable under the names Jeffamine®, D-Reihe (Huntsman Corp. Europe, Belgium), diethylene triamine, triethylene tetramine and hydrazine. Isophorone diamine, ethylene diamine, and 1,6-hexamethylene diamine are preferable. Ethylene diamine is particularly preferable.

Monoamines, such as butylamine, ethylamine and amines of Jeffamine® M-Reihe (Huntsman Corp. Europe, Belgium), amino-functional polyethylene oxides and polypropylene oxides can also be added proportionately.

In a further embodiment, the reaction mixture to produce polyurethane polymer having the (meth)acrylate groups also comprises the following components:

(b6) polyol compounds with a mean molecular weight of ≥500 g/mol to ≤13000 g/mol and with a mean hydroxyl functionality of ≥1.5 to ≤5.

Suitable higher molecular polyols (b6) are polyols (also including diols) with a number average molecular weight in the range ≥500 g/mol to ≤13000 g/mol, preferably ≥700 g/mol to ≤4000 g/mol. Polymers are preferred with a mean hydroxyl functionality of ≥1.5 to ≤2.5, preferably of ≥1.8 to ≤2.2, particularly preferably of ≥1.9 to ≤2.1. These include, for example, polyester alcohols based on aliphatic, cycloaliphatic and/or aromatic di-, tri- and/or polycarboxylic acids with di-, tri-, and/or polyols and polyester alcohols based on lactone. Polyester alcohols which are preferred are, for example, reaction products from adipinic acid with hexane diol, butane diol or neopentyl glycol or mixtures of the quoted diols of molecular weights of ≥500 g/mol to ≤4000 g/mol, particularly preferably ≥800 g/mol to ≤2500 g/mol. Also suitable are polyetherols which are obtainable by polymerisation of cyclic ethers or by reacting alkylene oxides with a starter molecule. Examples include the polyethylene- and/or polypropylene glycols of mean molecular weights ≥500 g/mol to ≤13000 g/mol, as well as polytetrahydrofuranes of mean molecular weights ≥500 g/mol to ≤8000 g/mol, preferably ≥800 g/mol to ≤3000 g/mol.

Hydroxyl-terminated polycarbonates are also suitable which are obtainable by reacting diols or lactone-modified diols also or bisphenols also, such as bisphenol A, with phosgene or carbonic acid diesters such as diphenylcarbonate or dimethylcarbonate. Examples include the polymeric carbonates of 1,6-hexane diol of mean molecular weight ≥500 g/mol to ≤8000 g/mol, and the carbonates of reaction products of 1,6-hexane diol with ϵ-caprolactone in the molar ratio ≥0.1 to ≤1. The aforementioned polycarbonate diols are preferred of mean molecular weight ≥800 g/mol to ≤3000 g/mol based on 1,6-hexane diol and/or carbonates of reaction products of 1,6-hexane diol with ϵ-caprolactone in the molar ratio ≥0.33 to ≤1. Hydroxyl-terminated polyamide alcohols and hydroxyl-terminated polyacrylate diols can also be used.

In a further embodiment, the number of hydroxyl groups in the component (b4) has a proportion of ≥5 mol-% to ≤25 mol-% to the total amount of hydroxyl groups and amino groups in the reaction mixture, wherein the hydroxyl groups of water are not taken into account in the reaction mixture in this case. This proportion can also be in a range ≥10 mol-% to ≤20 mol-% or ≥14 mol-% to ≤18 mol-%. This means that the number of OH groups in the component (b4) falls in the quoted ranges in the totality of the compounds carrying the OH— and NH₂ groups, i.e. in the totality of the components (b1), (b3), (b4) and (b5) as well as, if (b6) is also present, in the totality of the components (b1), (b3), (b4), (b5) and (b6). Water is ignored in the calculation. Due to the proportion of components (b4), the degree of branching of the polymers can be affected wherein a higher degree of branching is advantageous. By doing so, the drying property of the coating can be improved.

Moreover, the drying is improved by as many strong hydrogen group bonds between the molecules of the coating as possible. Urethane, urea, esters, in particular carbonate esters, are examples for structural units which aid drying, the more that are incorporated.

In a further embodiment, the reaction mixture for producing polyurethane polymers having (meth)acrylate groups also comprises the following components:

(b7) compounds not reactive to isocyanates and/or not reacted and comprising (meth)acrylate groups.

These compounds serve to increase the double bonding density of the coating. A high double bonding density increases the performance characteristics (resistance to mechanical or chemical influences) of the cured coating. They certainly influence the drying properties. Of these, preferably ≥1% w/w to ≤35% w/w, in particular ≥5% w/w to ≤25% w/w and quite particularly preferably ≥10% w/w to ≤20% w/w of the total amount of solids in the coating agent are used for this purpose. These compounds are also designated as reactive diluents in UV cured coating agent technology.

In a further embodiment, the surface of the nanoparticles in the coating is modified by the covalent and/or non-covalent bonding of other compounds.

A preferable covalent surface modification is the silanisation with alcoxysilanes and/or chlorosilanes. The partial modification with γ-glycidoxypropyltrimethoxysilane is particularly preferable.

An adsorptive/associative modification by surfactants or block copolymers is an example for the non-covalent case.

Furthermore, it is possible that the compounds, which are bonded to the surface of the nanoparticles covalently and/or non-covalently, also contain carbon-carbon double bonds. (Meth)acrylate groups are preferable in this case. In this manner, the nanoparticles can be bonded even more firmly in the binder matrix during radiation curing.

Furthermore, so-called cross-linking agents, intended to improve the drying and possibly the adhesion of the radiation-curable layer, can be added to the coating agent, which is dried on the radiation-curable layer. Preferably polyisocyanates, polyaziridines and polycarbodiimides can be considered. Hydrophilated polyisocyanates are particularly preferable for aqueous coating agents. The amount and the functionality of the cross-linking agents must be in line, in particular, with the desired deformability of the film. Generally, ≤10% w/w of solid cross-linking agents to the total solids content of the coating agent are added. Many of the possible cross-linking agents reduce the shelf life of the coating agent since they react slowly in the coating agent. For this reason, the addition of the cross-linking agents should take place at an appropriately short time before the application. Hydrophilated polyisocyanates are obtainable, for example, under the names Bayhydur® (Bayer Materialscience AG, Leverkusen, DE) and Rhodocoat® (Rhodia, F). When adding a cross-linking agent, the required time and temperature may increase until optimal drying is achieved.

Furthermore, additives and/or auxiliary agents and/or solvents which are common in the technical fields of paints, dyes and printing inks and with whose help the layer is produced, may be contained in the radiation-curable layer or, as the case may be, the coating agent. Examples of these are described below.

In particular, these stabilisers are light stabilisers such as UV absorbers and sterically hindered amines (HALS), as well as antioxidants and auxiliary paint agents, such as anti-setting agents, defoaming and/or wetting agents, flow agents, softeners, antistatic agents, catalysts, auxiliary solvents and/or thickeners and pigments, dyes and/or matting agents.

Suitable solvents must be matched to the binder used and to the application process with water and/or other solvents common in coating technology. Examples are acetone, ethyl acetate, butyl acetate, methoxypropyl acetate, diacetone alcohol, glycols, glycol ethers, water, xylol or solvent naphtha from the Exxon-Chemie company as an aromatic solvent, as well as mixtures of the listed solvents.

Furthermore, fillers and non-functional polymers to adjust the mechanical, haptic, electrical and/or optical properties can be included. All polymers and fillers are suitable for this which are compatible and can mix with the coating agent.

Polymers such as polycarbonates, polyolefines, polyethers, polyesters, polyamides and polyureas can be considered for polymeric additives.

Mineral fillers, in particular so-called matting agents, glass fibres, soot, carbon nanotubes (for example, Baytubes®, Bayer Materialscience AG, Leverkusen) and/or metallic fillers, such as those used for so-called metallic paints, can be used as fillers.

Furthermore, the reaction mixture can comprise the aforementioned further components, besides photoinitiators, additives and co-solvents, i.e. in particular (b3), (b4), (b5), (b6) and (b7). These components can be present in a reaction mixture according to the invention, for example, in the following amounts, wherein the sum the individual weight proportions is ≤100% w/w

(a): ≥5% w/w to ≤50% w/w, preferably ≥20% w/w to ≤40% w/w, more preferably ≥25% w/w to ≤35% w/w.

(b1): ≥10% w/w to ≤80% w/w, preferably ≥30% w/w to ≤60% w/w, more preferably ≥40% w/w to ≤50% w/w.

(b2): ≥0.1 to ≤8.0% w/w preferably ≥0.1 to ≤5.0% w/w particularly preferably ≥0.1 to ≤3.0% w/w

(b3): ≥0% w/w to ≤20% w/w, preferably ≥2% w/w to ≤15% w/w, more preferably ≥3% w/w to ≤10% w/w.

(b4): ≥0% w/w to ≤25% w/w, preferably ≥0.5% w/w to ≤15% w/w, more preferably ≥1% w/w to ≤5% w/w.

(b5): ≥0% w/w to ≤20% w/w, preferably ≥0.5% w/w to ≤10% w/w, more preferably ≥1% w/w to ≤5% w/w.

(b6): ≥0% w/w to ≤50% w/w, preferably=0% w/w.

(b7): ≥0% w/w to ≤40 % w/w, preferably ≥5% w/w to ≤30% w/w, more preferably ≥10% w/w to ≤25% w/w.

The reaction products from the reaction mixture are used to produce an aqueous dispersion in water. The proportion of the polyurethane polymers in the water can be in a range ≥10% w/w to ≤75% w/w, preferably ≥15% w/w to ≤55% w/w, more preferably ≥25% w/w to ≤40% w/w.

The proportion of the nanoparticles in the aqueous dispersion can be in a range ≥5% w/w to ≤60% w/w, preferably ≥10% w/w to ≤40% w/w, more preferably ≥15% w/w to ≤30% w/w.

The production of a polyurethane dispersion as an example for a coating of a film according to the invention can be performed in one or in a plurality of steps in a homogeneous, or if the reaction is multistage, partially in a dispersal phase. After a polyaddition performed completely or partially, a dispersal step is completed. Then, if necessary, a further polyaddition or a modification is performed, if necessary, in a dispersal phase.

To produce the polyurethane dispersion, methods can be used, for example, emulsion shear force, acetone, prepolymer mixing, melt emulsifying, ketimine and solids spontaneous dispersal methods or derivatives therefrom. The melt emulsifying method and the acetone method as well as mixed variants of these two methods are preferred.

Normally, the components (b1), (b2), (b3), (b4) and (b6), which have no primary or secondary amino groups, and a polyisocyanate (a) are placed completely or partially in the reactor to produce a polyurethane prepolymer and, if necessary, thinned with a solvent miscible with water but inert to isocyanate groups, but preferably without a solvent, and heated to higher temperatures, preferably in the range of ≥50° C. to ≤120° C.

Suitable solvents are, for example, acetone, butanone, tetrahydrofurane, dioxane, acetonitrile, dipropylene glycol dimethyl ether and 1-ethyl- or 1-methyl-2-pyrrolidone, which can be added not only at the beginning of the production but also later in parts. Acetone and butanone are preferable. Normally at the beginning of the reaction, only solvent is added at ≥60% w/w to ≤97% w/w, preferably ≥70% w/w to ≤85% w/w. Depending on variations in the method, in particular if the complete reaction is to happen before the dispersing, the addition of further solvent can be helpful in advancing the reaction.

It is possible to perform the reaction at normal pressure or elevated pressure, for example, above the boiling temperature at normal pressure of a solvent such as acetone.

Furthermore, in order to accelerate the isocyanate addition reaction, catalysts such as triethylamine, 1,4-diazabicyclo-[2,2,2]-octane, tin dioctoate, bismuth octoate or dibutyltin dilaurate can be included at first or metered in later. Dibutyltin dilaurate (DBTL) is preferred. Besides catalysts, it may be helpful to add stabilisers to protect the (meth)acrylate groups from spontaneous, undesired polymerisation. Usually, the compounds that are used with (meth)acrylate groups already contain these types of stabilisers.

Next, those components (a) and/or (b1), (b2), (b3), (b4) and (b6) having no primary or secondary amino groups, which were not already added at the start of the reaction, are metered in. During the production of the polyurethane prepolymer, the molar ratio of isocyanates groups to groups reactive with isocyanates is ≥0.90 to ≤3, preferably ≥0.95 to ≤2, particularly preferably ≥1.05 to ≤1.5. The reaction of the components (a) with (b) takes place in relation to the total amount of groups reactive with isocyanates of the part of (b) having no primary or secondary amino groups, wholly or partially, but preferably wholly. The degree of reaction is normally monitored by tracking the NCO content of the reaction mixture. In this process, both spectroscopic measurements, for example, infrared or near infrared spectra, determinations of the refractive index as well as chemical analyses, such as titrations, of extracted samples can be undertaken. Polyurethane prepolymers which can contain the free isocyanate groups, are obtained in substance or in solution.

If the production of the polyurethane prepolymers from (a) and (b) would still not be implemented in the starting molecules after or during the process, the partial or complete salt formation of the anionic and/or cationic dispersant-acting groups takes place. For this reason, in the case of anionic groups, bases such as ammonia, ammonium carbonate or ammonium hydrogen carbonate, trimethylamine, triethylamine, tributylamine, diisopropylethylamine, dimethylethanolamine, diethylethanolamine, triethanolamine, ethylmorpholine, potassium hydroxide or sodium carbonate are used, preferably triethylamine, triethanolamine, dimethylethanolamine or diisopropylethylamine. The amount of the bases is between ≥50% and ≤100%, preferably between ≥60% and ≤90% of the quantity of the anionic groups. In the case of cationic groups, for example, sulphuric acid dimethyl ester, lactic acid or bernstein acid are used. If nonionic hydrophilated compounds (b3) with ether groups only are used, the neutralisation step is omitted. The neutralisation can also take place at the same time as the dispersion wherein the dispersion water already contains the neutralisation agent.

The isocyanates groups which may still remain are converted by reacting with aminic components (b5) and/or, if present, aminic components (b3) and/or water. In this process, this chain elongation can be performed either in solvent before the dispersion or in water after the dispersion. If aminic components are contained in (b3), the chain elongation takes place preferably before the dispersion.

The aminic components (b5) and/or, if present, the aminic components (b3) can be added with organic solvents and/or diluted with water to the reaction mixture. Preferably ≥70% w/w to ≤95% w/w of solvents and/or water are used. If several aminic components (b3) and/or (b5) are present, then the reaction can take place in any sequence or simultaneously by adding a mixture.

During or following the production of the polyurethane, the nanoparticles with surface modification if applicable are introduced. This can be done by simply stirring the particles in. However, it is conceivable that enhanced dispersion power is used, as is possible, for example, by ultrasonics, jet dispersion or a high-speed stirrer on the rotor/stator principle. Simple mechanical stirring is preferable.

In principle, the particles can be used both in powder form as well as in the form of colloidal suspensions or dispersions in suitable solvents. The inorganic nanoparticles are used preferably in colloidal dispersal form in organic solvents (organosols) or particularly preferably in water.

Regarding the organosols, suitable solvents are methanol, ethanol, i-propanol, acetone, 2-butanone, methyl-isobutyl ketone, butyl acetate, ethyl acetate, 1-methoxy-2-propyl acetate, toluene, xylol, 1,4-dioxane, diacetone alcohol, ethylene glycol-n-propyl ether or any mixture of these solvents. Suitable organosols have a solids content of ≥10% w/w to ≤60% w/w, preferably ≥15% w/w to ≤50% w/w. Suitable organosols are, for example, silicon dioxide organosols, such as those obtainable under the trade names of Organosilicasol® and Suncolloid® (Nissan Chem. Am. Corp.) or under the name Highlink®NanO G (Clariant GmbH).

Insofar as the nanoparticles are used in organic solvents (organosols), they are mixed with the polyurethane during its production before their dispersion with water. The resulting mixtures are then dispersed by adding water or by conversion in water. The organic solvent of the organosol can be removed with water by distillation optionally before or after the dispersion with water, preferably following the dispersion.

Within the context of the present invention, furthermore, preferably inorganic particles in the form of their aqueous preparations are used. The use of inorganic particles in the form of aqueous preparations of surface-modified, inorganic nanoparticles is particularly preferred. These may be modified by silanisation, for example, before or simultaneously with the incorporation in the silane-modified, polymere organic binder or a aqueous dispersion of the silane-modified polymeric organic binder.

Preferable aqueous, commercial nanoparticle dispersions are obtainable under the names Levasil® (H.C. Starck GmbH, Goslar, Germany) and Bindzil® (EKA Chemical AB, Bohus, Sweden). Aqueous dispersions of Bindzil® CC 15, Bindzil® CC 30 and Bindzil® CC 40 from the EKA company (EKA Chemical AB, Bohus, Sweden) are used particularly preferably.

Insofar as the nanoparticles are used in aqueous form, these are added to the aqueous dispersions of the polyurethanes. In a further embodiment, during the production of the polyurethane dispersions, instead of water, the aqueous nanoparticle-dispersion diluted with water is used preferably.

For the purposes of producing the polyurethane dispersion, the polyurethane prepolymers are either added into the dispersion water, if necessary with strong shearing, by, for example, stirring vigorously, or, conversely, the dispersion water is stirred into the prepolymers. Then, if it has not yet happened in the homogenous phase, the increase in molecular weight can take place by a reaction of possibly present isocyanate groups with the component (b5). The amount of polyamine (b5) used depends on the still present, unreacted isocyanate groups. The material quantities of the isocyanates groups reacted with polyamines (b5) are preferably ≥50% to ≤100%, particularly preferably ≥75% to ≤95%.

The resulting polyurethane-polyurea polymers have an isocyanate content of ≥0% w/w to ≤2% w/w, preferably of ≥0% w/w to ≤0.5% w/w, in particular 0% w/w.

If necessary, the organic solvent can be distilled off. The dispersions may then have a solids content of ≥20% w/w to ≤70% w/w, preferably ≥30% w/w to ≤55% w/w, in particular ≥35% w/w to ≤45% w/w.

The coating of a film with the polymer dispersion is carried out preferably by rolling, squeegee, pouring, spraying or casting. Printing processes, dipping, transfer methods and painting are also possible. The application should take place excluding radiation which may result in the premature polymerisation of the acrylate and/or methacrylate double bonds of the polyurethane.

The drying of the polymer dispersion follows the application of the coating agent on to the film. This is performed, in particular, at elevated temperatures in ovens and with moving and, if necessary, also moistened air (convection ovens, jet driers) as well as thermal radiation (IR, NIR). Microwaves may be used also. It is possible and advantageous to use a plurality of these drying processes.

Advantageously, the conditions for the drying are selected such that, due to the elevated temperature and/or the thermal radiation, the polymerisation (cross-linking) of the acrylate or methacrylate groups is not triggered since this can impair the deformability. Furthermore, the maximum temperature reached is deliberately selected to be low enough that the film does not deform in an uncontrolled fashion.

After the drying/curing step, the coated film, possibly after lamination with a protective film on the coating, can be rolled out. The rolling can take place without the coating adhering to the reverse side of the substrate film or the lamination film. However, it is possible to cut the coated film to size and to forward the cut pieces, individually or stacked, to further processing.

### EXAMPLES

PUR dispersion II: Bayhydrol® XP 2648 aliphatic, polycarbonate-containing anionic polyurethane dispersion, solvent-free (Covestro Deutschland AG)

Esacure® One: photoinitiator (oligo-[2-hydroxy-2-methyl-1-((4-(1-methylvinyl)phenyl) propanone (Lamberti)

Irgacure® 819: photoinitiator (phenyl-bis (2,4,6-trimethylbenzoly) phosphine oxide (BASE SE)

Irgacure® 500: photoinitiator (mixture from 1-hydroxy-cyclohexylphenyl-ketone and benzophenone (BASE SE)

BYK 346: solution of a polyether-modified siloxane (BYK.Chemie)

Borchi® Gel 0625: nonionic thickener based on polyurethane for aqueous coating agent (OMG Borchers GmbH)

Tego®Glide: flow and slip additive

Tego®Wet: wetting agent

Bindzil® CC401: nanoparticles (Hedinger GmbH & Co. KG)

### Production of the PUR Dispersion I

In a reaction vessel with a stirrer, internal thermometer and gas feed (air flow 1 l/hr), 471.9 parts of the polyester acrylate Laromer® PE 44 F (BASF SE, Ludwigshafen, DE), 8.22 parts of trimethylolpropane, 27.3 parts of dimethylolpropionic acid, 199.7 parts of Desmodur® W (cycloaliphatic diisocyanate; Covestro Deutschland AG, Leverkusen, DE), and 0.6 parts of dibutyl tin dilaurate in 220 parts acetone were dissolved and reacted up to an NCO content of 1.47% w/w at 60° C. while stirring. 115.0 parts of the dipentaerythritol monohydroxy pentaacrylate Photomer® 4399 (BASF SE, Ludwigshafen, DE), were added to the prepolymer solution thus obtained and stirred in.

Then it was cooled to 40° C. and 19.53 g of triethylamine were added. After stirring for 5 minutes at 40° C., the reaction mixture was poured into 1200 g of water at 20° C. and stirred rapidly. Next 9.32 g of ethylene diamine in 30.0 g water were added.

After 30 min of stirring without heating or cooling, the product was distilled in a vacuum (50 mbar, max. 50° C.), until a solid of 40±1% w/w was achieved. The dispersion had a pH value of 8.7 and a z-average value for the particle diameter of 130 nm. The flow time into a 4 mm beaker was 18 sec. The weight average molar weight mw of the polymer obtained was determined at 307840 g/mol.

TABLE 1
Composition of the coating agent

| | Coating | Coating | Coating |
|---|---|---|---|
| | agent A | agent B | agent C |
| Input substance | % w/w | % w/w | % w/w |
| PUR dispersion I | 55.1 | 54.9 | 54.9 |
| PUR dispersion II | 9.1 | 9.1 | 9.1 |
| Bindzil ® CC401 | 23.9 | 23.8 | 23.8 |
| 4-hydroxy-4-methyl- | 4.9 | 4.9 | 4.9 |
| pentane-2-on | | | |
| 1-methyl-2-propanol | 4.9 | 4.9 | 4.9 |
| Photoinitiator | Esacure ® one | Irgacure ® 819 | Irgacure ® 500 |
| | 0.7 | 1.0 | 1.0 |
| Tego ®Glide 410 | 0.3 | 0.3 | 0.3 |
| Tego ®Wet 280 | 0.3 | 0.3 | 0.3 |
| BYK 346 | 0.3 | 0.3 | 0.3 |
| Borchi ® Gel 0625 | 0.3 | 0.3 | 0.3 |
| n,n-dimethyl ethyl | 0.2 | 0.2 | 0.2 |
| amine | | | |
| Total | 100.0 | 100.0 | 100.0 |

### Production of the Aqueous Radiation-Curable Coating Agent

According to the quantity data in Table 1, the coating agents A to C were produced by providing diacetone alcohol and 2-methoxypropanol, after which the additives Tego®Glide 410, Tego®Wet 280 and BYK®346 as well as the respective photoinitiator were introduced while stirring and then stirred at 23° C. to completely dissolve all components. Then, the solution was filtered using a 5 μm bag filter.

The PUR dispersions I and II were introduced and stirred for 5 min at 500 rpm. While stirring vigorously (1000 rpm), within 5 minutes, the previously produced solution of the photoinitiator was added.

Next, the pH value was adjusted to pH 8.0 to 8.5 by adding n,n-dimethylethylamine while stirring (500 rpm). While continuing to stir (500 rpm), within 10 minutes Bindzil® CC 401 was added and stirring continued for another 20 minutes. If, after this continued stirring, the pH value was still <8, it was readjusted to pH 8.0 to 8.5 by the further addition of n,n-dimethylethylamine. Borchi® Gel 0625 was interdispersed with the dissolver while stirring vigorously (1000 rpm) and stirred for another 30 minutes at 1000 rpm. Finally, the dispersion was filtered through a 10 μm bag filter.

### Application of the Polymer Dispersions to Plastic Films

The coating agents A to C according to Table 1 were applied with a conventional squeegee (target wet layer thickness 100 μm) on one side of a polycarbonate plastic film (Makrofol® DE1-1, film thickness 250 μm and 375 μm, sheet size DIN A4). After an airing phase of 10 minutes at 20° C. to 25° C., the painted films were dried or pre-cross-linked for 10 minutes at 110° C. in a convection oven. The painted films produced in this manner were touch-dry at this stage in the process chain.

### UV Curing of the Coated Plastic Films

UV LED modules from the IRIS range from the Heraeus-Noblelight company were used for the curing of the coated plastic films. In particular modules were used which emit UV light of wavelength 365 nm or 395 nm. In addition, a conventional UV emitter was used which emits at 220 nm, i.e. in the UVC range, in order to optimise the surface curing.

The temperature of the plastic film to be cured was preheated before UV curing in a convection oven at 120° C. Using a temperature probe (Tesco 830-T2, infrared thermometer) it was ensured that all test pieces would undergo the UV curing with a surface temperature of 80-100° C.

The UV dose applied for the curing was determined with a Lightbug ILT 490 (International Light Technologies Inc., Peabody Mass., USA). A UV dose of 5.2 j/cm² was radiated at 365 nm. A dose of 6.7 j/cm² was used at 395 nm. The UVC emitter only started up with the dose at 71 mj/cm² because the Lightbug displays practically no absorption in this wave-length range.

### Test Methods to Assess the UV Cross-Linking of the Coating Agent

The steel wool scratch test involves a determination wherein a steel wool no. 00 (Oskar Weil GmbH Rakso, Lahr, Germany) is cemented to the flat end of a 500 g fitter's hammer. The hammer is placed with no added pressure on the face being tested so that a defined load of approx. 560 g is achieved. The hammer is then moved back and forth 10 times in double strokes. Then the affected surface is cleaned with a soft cloth to remove remaining bits of fabric and paint particles. The scratching is characterised in terms of haze and gloss values, and measured across the direction of scratching with the Micro HAZE plus (20° gloss and haze; BYK-Gardner GmbH, Geretsried, Germany). The measurement is carried out before and after scratching. The differential values for gloss and haze before and after testing are stated as Δgloss and Δhaze.

The resistance to solvents of the coatings was tested conventionally for technical quality with isopropanol, xylol, 1-methoxy-2-propylacetate, ethylacetate, and acetone. The solvents were applied to the coating with a soaked cotton pad and protected from evaporation by covering. Unless otherwise stated, an active time of 60 minutes at approx. 23° C. was maintained. Once the active period had finished, the cotton pad was removed and the test surface wiped clean with a soft cloth. The sampling was done immediately, both visually and by lightly scratching with the fingernail.

The following distinctions were made:
0=unchanged; no changes visible; undamaged by scratching.
1=slight swelling visible, but undamaged by scratching.
2=change clearly visible, scarcely damaged by scratching.
3=appreciably changed, superficially destroyed after firm fingernail pressure.
4=severely changed, after firm fingernail pressure scratched through to substrate.
5=destroyed; just by wiping off the chemical the paint is destroyed; the test substance cannot be removed (eaten into).

Within this assessment, the test with the marks 0 and 1 usually means that it has passed. Marks >1 stand for a “not passed”.

The resistance to solvents is characterised by 5 numbers which reflect the result of the solvent in the above sequence.

TABLE 2
Results of the UV LED curing with a wavelength of 365 nm

| | | | Steel wool | |
|---|---|---|---|---|
| | | UVC | Δhaze/Δ20°- | |
| No. | Coating agent | Y/N | gloss | Solvent test |
| 1 | A | N | 55/32 | 00005 |
| 2 | B | N | 219/60 | 00035 |
| 3 | C | N | 305/73 | 20045 |
| 4 | A | Y | 5/3 | 00003 |
| 5 | B | Y | 65/28 | 00045 |
| 6 | C | Y | 160/43 | 00035 |

TABLE 3
Results of the UV LED curing with of a wavelength of up to 395 nm

| | | | Steel wool | |
|---|---|---|---|---|
| | | UVC | Δhaze/Δ20°- | |
| No. | Coating agent | Y/N | gloss | Solvent test |
| 7 | A | N | 400/159 | 00005 |
| 8 | B | N | 309/135 | 00045 |
| 9 | C | N | 301/69 | 10045 |
| 10 | A | Y | 32/10 | 00004 |
| 11 | B | Y | 62/26 | 00045 |
| 12 | C | Y | 165/46 | 00035 |

It can be seen that coating agent C virtually does not react to the pure LED curing. At both wavelengths, scratching and solvent resistance are both moderate to bad.

Coating agent A reacts clearly to the radiation at 365 nm. The solvent resistance is already relatively good. Certainly, the surface without UVC radiation is still scratch sensitive. However, with UVC radiation a good level is achieved regarding scratching and solvent resistance.

Coating agent B reacts to the radiation with the pure LED worse than coating agent A. Both the solvent resistance as well as the scratch resistance are moderate. Acceptable values for the scratch resistance are only achieved with the additional use of UVC light.

1.-13. (canceled)

14. A method for producing shaped bodies having a radiation-cured coating, comprising
preparation of a coated film, wherein the film comprises a radiation-curable coating, wherein the coating comprises a polyurethane polymer, which has (meth)acrylate groups and which is obtainable from the reaction of a reaction mixture comprising:
(a) polyisocyanates and
(b1) compounds which are reactive to isocyanates and which comprise (meth)acrylate groups
(b2) at least one photoinitiator
and wherein the coating furthermore comprises inorganic nanoparticles with a mean particle size of ≥1 nm to ≤200 nm,
shaping of the shaped body
curing the radiation-curable coating by LED UV radiation.
optionally after the curing with LED UV radiation, curing with UVC radiation.

15. The method according to claim 14, wherein the shaping of the shaped body takes place in a tool at a pressure of ≥20 bar to ≤150 bar.

16. The method according to claim 14, wherein the shaping of the shaped body takes place at a temperature of ≥20° C. to ≤60° C. below the softening temperature of the material of the film.

17. The method according to claim 14, furthermore comprising the step:
applying a polymer to the side of the film opposite the cured layer.

18. The method according to claim 14, wherein the film is a polycarbonate film with a thickness of ≥10 μm to ≤1500 μm.

19. The method according to claim 14, as photoinitiator (b2), a photoinitiator is selected from the group consisting of acylphosphinoxides, such as 2,4,6-trimethyl-benzoyl-di-phenylphosphine oxide, bisacyl phosphine oxides such as bis(2,4,6-trimethylbenzoyl)-phenyl phosphine oxide, α-hydroxyalkyl phenones, oligomeric α-hydroxyalkyl phenones such as oligo-[2-hydroxy-2-methyl-1-((4-(1-methylvinyl)phenyl) propanone] and/or mixtures thereof.

20. The method according to claim 14, wherein the photoinitiator (b2) is a compound selected from the group consisting of α-hydroxyalkyl phenones, oligomeric α-hydroxyalkyl phenones such as oligo-[2-hydroxy-2-methyl-1-((4-(1-methyl vinyl)phenyl) propanone] and/or mixtures thereof.

21. The method according to claim 14, wherein the reaction mixture furthermore comprises the following components:
(b3) hydrophilic-acting compounds with ionic and/or groups convertible into ionic groups and/or nonionic groups
(b4) polyol compounds with a mean molecular weight of ≥50 g/mol to ≤500 g/mol and of hydroxyl functionality of ≥2 and
(b5) amino functional compounds.

22. The method according to claim 14, wherein the reaction mixture furthermore comprises the following components:
(b6) polyol compounds with a mean molecular weight of ≥500 g/mol to ≤13000 g/mol and of a mean hydroxyl functionality of ≥1.5 to ≤5.

23. The method according to claim 14, wherein the coating furthermore comprises the following components:
(b7) compounds not reactive to isocyanates and/or not reacted and comprising (meth)acrylate groups.

24. The method according to claim 14, wherein the surface of the nanoparticles in the coating is modified by the covalent and/or non-covalent bonding of other compounds.

25. The method according to claim 14, wherein component (b2) is contained in a 0.1 to ≤8.0% w/w.

26. A shaped body obtained by the method according to claim 14.
